(19) United States
(12) Patent Application Publication
(10) Pub. No.: US 2025/0337355 A1
(43) Pub. Date: Oct. 30, 2025

(54) SYSTEM FOR EXERGY GENERATION

(71) Applicant: Deniz KAZANCI, Upland, CA (US)

(72) Inventor: Deniz KAZANCI, Upland, CA (US)

(21) Appl. No.: 19/260,231

(22) Filed: Jul. 3, 2025

Related U.S. Application Data
(63) Continuation-in-part of application No. 16/627,381, filed on Dec. 30, 2019, now Pat. No. 12,380,516.

(30) Foreign Application Priority Data
Jun. 30, 2017 (TR) 2017/09660

(51) Int. Cl. H02S 40/44

(52) U.S. Cl. CPC H02S 40/44

(57) ABSTRACT

A system for exergy generation. According to an embodiment of the present disclosure, there is provided a system, including: a first energy input; a heat output, configured to deliver a portion of an energy flow received at the first energy input; a heat flow regulator, for controlling a rate of heat flow through the heat output; a first sensor; and a controller, the controller being configured to: receive a measurement from the first sensor, and control the heat flow regulator to cause heat to flow at a first heat flow rate through the heat output, the system producing a greater outflow rate of exergy at the first heat flow rate than at a second heat flow rate different from the first heat flow rate.

### CROSS-REFERENCE TO RELATED APPLICATION(S)

The present application is a continuation-in-part of U.S. patent application Ser. No. 16/627,381, filed Dec. 30, 2019, which is a National Stage application of International Application No. PCT/TR2018/000061, filed Jun. 28, 2018, which claims priority to Turkish Patent Application No. TR2017/09660, filed Jun. 30, 2017; the entire contents of all of the applications identified in this paragraph are incorporated herein by reference.

### FIELD

One or more aspects of embodiments according to the present disclosure relate to power and heat transfer, and more particularly to a system for exergy generation.

### BACKGROUND

Various systems for transforming energy may have energy inputs and energy outputs, and parameters that may be adjusted to influence the rate of flow of one or more types of energy.

It is with respect to this general technical environment that aspects of the present disclosure are related.

### SUMMARY

According to an embodiment of the present disclosure, there is provided a system, including: a first energy input; a heat output, configured to deliver a portion of an energy flow received at the first energy input; a heat flow regulator, for controlling a rate of heat flow through the heat output; a first sensor; and a controller, the controller being configured to: receive a measurement from the first sensor, and control the heat flow regulator to cause heat to flow at a first heat flow rate through the heat output, the system producing a greater outflow rate of exergy at the first heat flow rate than at a second heat flow rate different from the first heat flow rate.

In some embodiments: the first energy input is an input for receiving solar radiation; and the system further includes: a photovoltaic panel, and a heat sink, configured to receive heat energy and to transfer the heat energy to the fluid.

In some embodiments, the heat output includes a fluid flow circuit for a fluid.

In some embodiments, the heat flow regulator includes a pump.

In some embodiments, the heat flow regulator includes a valve.

In some embodiments, the heat output includes a heat pipe.

In some embodiments, the heat flow regulator includes a variable-thermal-conductance element in a thermal conduction path including the heat pipe.

In some embodiments the system further includes a means for causing a fluid to flow in the fluid flow circuit.

In some embodiments, the means for causing the fluid to flow includes convection.

In some embodiments, the heat flow regulator includes a valve.

In some embodiments, the means for causing the fluid to flow includes a pump.

In some embodiments, the heat flow regulator includes a valve.

In some embodiments, the first sensor includes a temperature sensor.

In some embodiments, the temperature sensor is configured to measure an outlet fluid temperature.

In some embodiments the system further includes a second sensor.

In some embodiments, the second sensor is configured to measure an inlet fluid temperature.

In some embodiments, the second sensor is configured to measure a flow rate.

In some embodiments, the controller is configured to control a voltage or a current to control the heat flow regulator.

### BRIEF DESCRIPTION OF THE DRAWINGS

These and other features and advantages of the present disclosure will be appreciated and understood with reference to the specification, claims, and appended drawings wherein:

FIG. 1 is a block diagram of an energy conversion system, according to an embodiment of the present disclosure;

FIG. 2 is a block diagram of a thermal photovoltaic system, according to an embodiment of the present disclosure.

### DETAILED DESCRIPTION

The detailed description set forth below in connection with the appended drawings is intended as a description of exemplary embodiments of a system for exergy generation provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

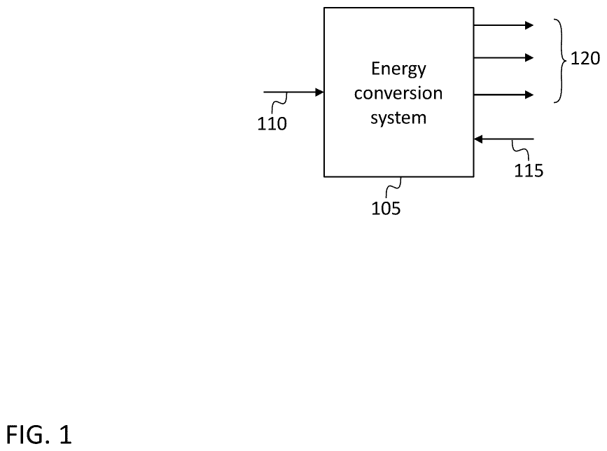

FIG. 1 is a block diagram of an exergy-maximizing system 105 for energy conversion, which may be employed for converting energy received from an energy source (e.g., sunlight) to other forms of energy (e.g., electric power and heat). The exergy-maximizing system 105 has one or more energy inputs, including a primary energy input 110 and one or more secondary energy inputs 115, and one or more energy outputs 120. The primary input 110 may be an input through which energy flows into the system at the greatest rate. The system converts the energy received at the primary energy input 110 into one or more other forms of energy, one of which is heat energy, and produces an outflow of energy at the one or more energy outputs. To the extent that the system does not store energy, the net energy inflow and outflow may be zero (e.g., the energy outflow through the energy outputs may equal the energy inflow through the energy inputs). The outflow rate of exergy, however, which may be defined as net rate of outflow of exergy excluding the exergy flowing into the system through the primary energy input 110 from the energy source, may vary depending on the setting of a heat flow regulator.

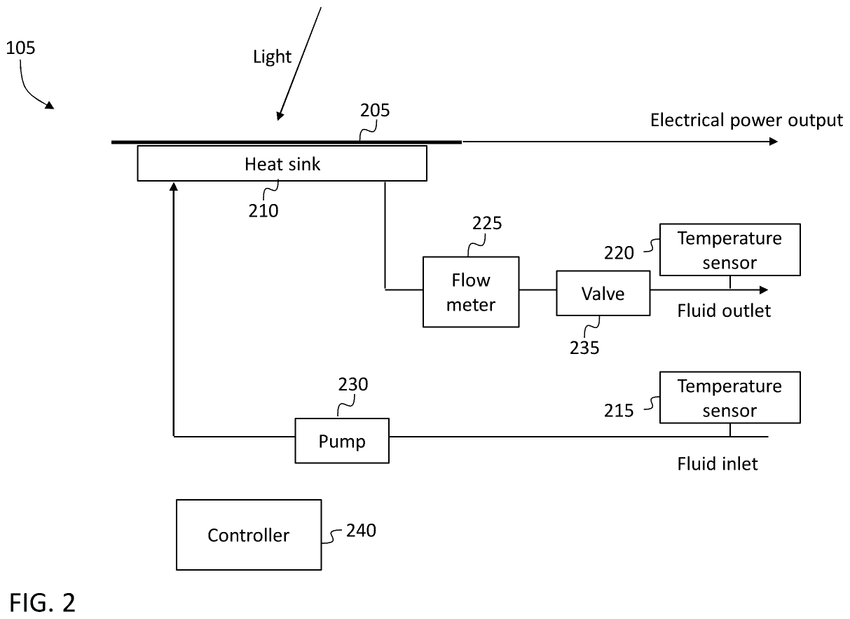

For example, FIG. 2 shows a thermal photovoltaic system, including a photovoltaic panel 205, a heat sink 210, an inlet temperature sensor 215, an outlet temperature sensor 220, a flow meter 225, a pump 230, a valve 235, and a controller 240 (which may be a processing circuit, and which may be connected to, and configured to control, or receive measurements from, each of the photovoltaic panel 205, the heat sink 210, the inlet temperature sensor 215, the outlet temperature sensor 220, the flow meter 225, the pump 230, the valve 235). In operation, the photovoltaic panel 205 absorbs sunlight and converts the energy of the sunlight into (i) electrical power (which flows out of the system through an electrical power output) and (ii) heat. The heat is conducted into the heat sink 210 and extracted from the heat sink by a flow of fluid (e.g., coolant), which is heated as a result. The fluid flows into the system at a first temperature at a fluid inlet, and flows out of the system, at a second temperature, higher than the first temperature, at a fluid outlet.

The outflow rate of exergy of the system, through the energy outputs (i.e., excluding any exergy that may flow into the system from the energy source), may be calculated according to

$${Ex}_{out} = {P}_{e} \cdot ε + {Q}_{h} ( 1 - {T}_{ref} / {T}_{out} ) - {Ex}_{loss}$$

where Pₑ is the electrical energy output (e.g., the product of the current and the voltage), Pₑ·ε is the electrical exergy output, Qₕ (1−T_{ref}/Tₒᵤₜ) is the thermal (heat) exergy output, ε is the electical exergy conversion factor which may be equal to, or nearly equal to 1, (1−T_{ref}/Tₒᵤₜ) is a Carnot coefficient, representing the theoretical maximum work extractable from a thermal source at temperature Tₒᵤₜ, when a heat sink at temperature T_{ref} is available, and Exₗₒₛₛ is the exergy loss in the system.

The rate of heat flow through the heat output may be given by:

$${Q}_{h} = {mC}_{p} Δ T = ( ρ V ) {C}_{P} ( {T}_{out} - {T}_{i n} )$$

where m is the mass flow rate, C_{ρ} is the specific heat capacity (per unit mass), ΔT is the difference between the fluid inlet and outlet temperatures, ρ is the density of the fluid, V is the volume flow rate of the fluid, and Tₒᵤₜ and Tᵢₙ are the fluid outlet and inlet temperatures, respectively.

The heat flow regulator may be any component or combination of components capable of regulating the rate Qₕ at which heat flows out of the system. In a system with fluid flow, as illustrated in FIG. 2, the fluid flow may be caused by a pump (which may be part of the system, or external), or by any other mechanism, such as convection, and the heat flow regulator may be any one of, or any suitable combination of, a pump with a controllable pumping speed (or “variable speed pump”) or one or more valves . . . Other examples include variable conductance heat pipe with non-condensable gas reservoir, electroosmotic flow controller, electrokinetic flow controller, electrohydrodynamic pump, thermoelectric module, phase-change material with controlled charging/discharging.

In some embodiments, heat may flow out through a heat pipe, or other than through the flow of a fluid. For example, heat may flow out through a conductive path. In such an embodiment, any suitable system for controlling the rate of heat flow (e.g., an internal valve, in a heat pipe) may be operated as the heat flow regulator. In some embodiments, heat flow into a conductive path or heat pipe may be regulated by adjusting the width of a fluid-filled gap (or of a gap filled with a deformable solid, e.g., a thermally conductive gel) between one end of the heat pipe and the heat sink (thereby changing the thermal conductivity of the heat flow path through the fluid). In another embodiment heat couples from the heat sink to the heat pipe by radiative heat transfer across a gap, and the rate of such radiative heat transfer is controlled by varying the extent to which a barrier (e.g., a reflective (e.g., metal) screen) extends across the gap.

In systems designed for exergy-maximized fluid flow heat exchange without relying on mechanical pumps or valves, several advanced methods can be employed and intelligently controlled by a microcontroller. Variable conductance heat pipes regulate internal vapor flow resistance by controlling non-condensable gas, with the microcontroller adjusting the gas reservoir to maintain an optimal temperature gradient and exergy transfer. Electroosmotic and electrokinetic flow controllers use electric fields to move ionic fluids through microchannels, with the microcontroller modulating voltage to precisely manage flow rate and direction for efficient heat exchange. Electrohydrodynamic (EHD) pumps, which lack moving mechanical parts, drive dielectric fluids using electric fields, and their flow rates can be dynamically tuned by the microcontroller to match real-time thermal demands. Thermoelectric modules also enable solid-state heat pumping, where the microcontroller controls current to transfer heat only when the exergy benefit outweighs the electrical cost. Additionally, phase-change materials with controlled charging can be managed by the microcontroller to schedule heating or cooling cycles optimally, leveraging latent heat transfer to store or release energy when it best aligns with exergy-optimized operating windows. Together, these approaches provide flexible, efficient, and pump-free means of maximizing useful work output in fluid-based thermal management systems.

The exergy loss Exₗₒₛₛ may be loss of exergy due to any conversion of work to heat that occurs within the system, including any exergy lost in operating a pump, or valves or the controller 240 (which may be a processing circuit).

Work (e.g., electrical power) that is used within the system 105 (e.g., to turn a pump or to open or close a valve) may be supplied internally from an energy flow within the system (e.g., a portion of the electrical power produced by the photovoltaic panel 205 may be used) or supplied to the system (from a source outside of the system) through a secondary energy input 115. In either case, any such work that may be converted to heat within the system may be part of the exergy loss EXₗₒₛₛ.

In operation, a certain rate of heat flow may maximize the outflow rate of exergy. For example, in the system of FIG. 2, if the fluid flow rate is too low (e.g., if it is zero), then the temperature of the photovoltaic panel 205 may increase, reducing its efficiency and the exergy generated by the exergy-maximizing system 105. If, on the other hand, the fluid flow rate is too high, the temperature of the fluid at the fluid outlet may be so low that the Carnot coefficient (1−T_{ref}/Tₒᵤₜ) is small, and exergy that could be recovered from the heat energy of the fluid may not be recovered, reducing the outflow rate of exergy. Between these two extremes there may be a fluid flow rate at which the outflow rate of exergy is maximized. The operating point corresponding to this fluid flow rate may be referred to as the peak operating point.

As such, in some embodiments, the controller 240 adjusts the fluid flow rate in operation so that the operating point of the system is at or near the peak operating point (e.g., so that the outflow rate of exergy is at least equal to a fraction between 70% and 100% of the maximum outflow rate of exergy (e.g., so that the outflow rate of exergy is at least 80% of the maximum outflow rate of exergy, e.g., at least 95% of the maximum outflow rate of exergy)). This may be accomplished in various ways. For example, the controller 240 may periodically calculate the outflow rate of exergy, and make small test adjustments to the fluid flow rate, to assess whether adjusting the fluid flow rate increases or decreases the outflow rate of exergy. If a test adjustment results in an increase in the outflow rate of exergy, then the adjusted fluid flow rate may become the new operating point. If a test adjustment results in a decrease in the outflow rate of exergy, then it may be reversed, and the next test adjustment may be an adjustment in the opposite direction.

In some embodiments, a model of the system is used to predict the outflow rate of exergy as a function of the fluid flow rate. Such a model may include a model of the efficiency (e.g., the ratio of electrical power generated to solar influx) of the photovoltaic panel 205 as a function of temperature, and a model of the temperature at the fluid outlet as a function (i) of the fluid flow rate, (ii) of the temperature at the fluid inlet, and (iii) of the solar influx. The model may be exercised by the controller 240 in real time (e.g., the controller 240 may calculate the outflow rate of exergy for various possible fluid flow rates) and the controller 240 may periodically adjust the fluid flow rate to the flow rate that, according to the model, will result in the greatest outflow rate of exergy. In other embodiments, the model may be exercised off line and used to construct a lookup table from which the controller 240 may determine, in operation, to what rate the fluid flow should be adjusted to achieve the greatest outflow rate of exergy.

Some embodiments may be used in a thermal photovoltaic system, such as that of FIG. 2, or in various other types of system, in which the energy source may be different from solar radiation. For example, the energy source may be or include the receiver of a concentrated solar power (CSP) system. In such an embodiment, an exergy-maximizing system 105 may regulate fluid flow through receivers to minimize entropy and enhance turbine input conditions. Other examples of applications in which the system 105 may be used include, in the area of oil and gas, energy sources (e.g., heat sources) associated with upstream and midstream facilities, energy sources (e.g., heat sources) associated with heat recovery from flaring, energy sources (e.g., heat sources) associated with gas compression, or energy sources (e.g., heat sources) associated with crude stabilization processes. In such applications the use of an exergy-maximizing system 105 for energy conversion may have the additional benefit of lowering emissions as it also has in the solar photovoltaic thermal applications.

In the area of the food and beverage industry, examples of applications in which an exergy-maximizing system 105 may be used include energy sources (e.g., heat sources) associated with pasteurization, fermentation, and distillation. In such an application, the use of passive (e.g., convection-driven) circulation may also reduce contamination risks by reducing the number of moving parts. In the area of the pharmaceuticals industry, examples of applications in which an exergy-maximizing system 105 may be used include energy sources (e.g., heat sources) associated with cleanrooms, sterilizers, and reactor vessels.

In the area of the aerospace and aviation industry, examples of applications in which the exergy-maximizing system 105 may be used include energy sources (e.g., heat sources) associated with spacecraft and aviation systems. With minimal moving parts and ultra-low power demands, such embodiments are ideal for spacecraft and aviation systems, in which such embodiments may aid in thermal regulation of electronic payloads and environmental control systems under extreme energy constraints.

In the area of the agricultural and farming systems, examples of applications in which the exergy-maximizing system 105 may be used include energy sources (e.g., heat sources) associated with greenhouses, aquaponic systems, and geothermal-enhanced irrigation. In some implementations, the exergy-maximizing system may include a microprocessor-controlled thermal management circuit applied to energy-consuming environments such as greenhouses, aquaponic systems, and geothermal-enhanced irrigation. While these systems are not energy sources themselves, they rely on controlled heat delivery to maintain optimal biological or environmental conditions. The microprocessor dynamically regulates the timing, routing, and magnitude of heat flow based on real-time exergy analysis—ensuring that thermal energy is delivered precisely when and where it provides maximum useful effect, with minimal entropy generation. This enables high-efficiency operation of passive or hybrid systems, particularly in off-grid or resource-constrained settings and extends the principles of exergy optimization beyond power generation to heat utilization domains.

In the area of household and municipal utilities, the exergy-maximizing system 105 may be used for domestic water heating, radiant floor heating, and smart-grid-responsive HVAC systems. It replaces traditional circulation pumps, improving net system efficiency.

In the area of waste heat recovery or combined heat and power (CHP) plants, examples of applications in which the exergy-maximizing system 105 may be used include energy sources (e.g., heat sources) associated with waste heat recover and CHP plants. In waste heat recovery or combined heat and power (CHP) systems, the controller 240 ensures that only high-quality (low-entropy) heat is extracted and transferred—enhancing turbine performance and reducing fuel consumption. In the area of industrial processes, examples of applications in which the exergy-maximizing system 105 may be used include energy sources (e.g., heat sources) associated with various manufacturing and materials processing operations, which may generate significant low-grade heat. In such an embodiment, the exergy-maximizing system 105 for energy conversion intelligently routes fluid to capture and reuse this energy with minimal loss.

In the area of carbon reduction and policy compliance, examples of applications in which the exergy-maximizing system 105 may be used include energy sources (e.g., heat sources) associated with high-efficiency electric or hybrid heating systems, improving heat pump efficiency while offering a fossil-fuel-free alternative.

In the area of HVAC and heat pumps, examples of applications in which the exergy-maximizing system 105 may be used include energy sources (e.g., heat sources) associated with district heating and heat pump water heater systems. In such a system, the controller 240 may synchronize fluid movement with high-exergy operating windows, enhancing the coefficient of performance (COP) of the heat pump and drastically reducing electricity use.

In the area of exergy-optimized cooling in data centers, examples of applications in which the exergy-maximizing system 105 may be used include energy sources (e.g., heat sources) associated with data center computing circuits. In such an embodiment, the exergy-maximizing system 105 for energy conversion may optimize data center cooling by adjusting fluid flow based on real-time exergy analysis, ensuring cooling is only applied when it provides net thermodynamic benefit. It reduces energy waste, improves power usage effectiveness (PUE), and may operate in both active and passive cooling configurations.

By minimizing entropy generation and ensuring that every unit of energy transferred contributes to useful work, some embodiments align perfectly with global goals for carbon neutrality, energy independence, energy transition, and sustainable infrastructure. The system's passive nature, minimal power requirements, and thermodynamic intelligence make it a practical and transformative solution for the future of energy.

Optimizing fluid flow and heat difference in thermal systems based on exergy may rely on intelligent real-time management, something a microcontroller is uniquely suited to handle. By continuously monitoring temperatures, pressures, and flow rates, the microcontroller calculates the system's net exergy output and dynamically adjusts flow control devices to maximize useful energy while minimizing losses.

In systems that rely on natural convection or thermosiphon effects, such as heat pipes, microcontrollers may actuate valves or thermal switches to enable fluid circulation only when it enhances exergy efficiency. This selective activation prevents unnecessary flow, reducing energy waste and improving overall system performance.

Beyond fluid flow, microcontrollers may also regulate thermal energy input and heat rejection mechanisms to maintain an optimal temperature gradient within the heat pipe. For example, the microcontroller may modulate the power supplied to the heater at the evaporator section by adjusting the voltage or current, controlling the rate of vaporization of the working fluid. This precise control helps maintain a stable and efficient phase change process that maximizes heat transfer.

In certain closed or controlled systems, an electrical heater is required to initiate or sustain heat flow where external heat sources like sunlight or ambient thermal energy are unavailable, insufficient, or unreliable. Unlike open systems such as solar thermal collectors, which passively absorb environmental heat, closed systems must generate their own heat to maintain the necessary temperature difference for effective operation. In these cases, a microprocessor-controlled electrical heater at the heat input side, often called the “evaporator section” of the heat pipe, provides this critical function.

The microprocessor plays a central role in maximizing exergy by precisely managing the heat input and regulating the temperature difference across the heat pipe. By continuously monitoring temperature sensors and other system variables, the microcontroller dynamically adjusts the power delivered to the electrical heater, fine tuning voltage or current to control the rate at which the working fluid inside the heat pipe vaporizes. This ensures that the evaporator remains at an optimal temperature, sustaining an efficient phase change process that enables high heat transfer with minimal entropy generation.

On the heat rejection side, the “condenser section,” the microcontroller may simultaneously control active cooling elements such as fans or thermoelectric coolers to extract heat at just the right rate to preserve a stable and optimal temperature difference across the pipe. By doing so, it prevents both underperformance due to low heat flow and energy loss due to excessive cooling or overheating, ensuring that the entire thermal management system operates near its exergy optimal state.

This kind of microcontroller-driven thermal control is critical in applications like spacecraft thermal regulation, battery heating in cold climates, environmental test chambers, and precision industrial enclosures. In each case, the system requires a self-contained and finely tuned heat source. The microprocessor ensures that every unit of electrical energy added to the heater contributes effectively to useful work, maximizing the system's exergy output while minimizing waste.

Microcontrollers may regulate heat input and heat rejection in different parts of a heat pipe to maintain an optimal temperature difference for efficient operation. For example, at the heat-absorbing end of the pipe (the “evaporator section”), the microcontroller can control power delivered to an electrical heater, adjusting voltage or current to control the rate at which the working fluid vaporizes. This enables precise control over the heat transfer process.

At the heat-releasing end (the “condenser section”), the microcontroller can adjust cooling mechanisms such as the speed of a fan or the current supplied to a thermoelectric cooler. These devices remove heat from the condenser end in a controlled way, maintaining a stable temperature difference across the heat pipe that maximizes exergy transfer while avoiding thermal losses.

Additionally, microcontrollers may manage variable thermal contacts or adjust surface emissivity with smart materials or coatings. This allows fine-tuned control of heat rejection to adapt to changing environmental conditions and sustain the optimal thermal gradient.

Overall, microcontroller-based methods for heat pipes include controlling fluid circulation paths without mechanical pumps, modulating thermal input at the evaporator, and actively managing heat rejection at the condenser. By continuously analyzing exergy metrics and adjusting in real time, the system can minimize exergy loss, achieving high efficiency with low energy consumption. This integration of sensing, exergy-based control algorithms, and adaptive actuation provides a powerful solution for advanced thermal management that avoids conventional pumping.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X−Y and the second quantity is at most X+Y. As used herein, when a second number is “within Y %” of a first number, it means that the second number is at least (1−Y/100) times the first number and the second number is at most (1+Y/100) times the first number. As used herein, the word “or” is inclusive, so that, for example, “A or B” means any one of (i) A, (ii) B, and (iii) A and B.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Although exemplary embodiments of a system for exergy generation have been specifically described and illustrated herein, many modifications and variations will be apparent to those skilled in the art. Accordingly, it is to be understood that a system for exergy generation constructed according to principles of this disclosure may be embodied other than as specifically described herein. The invention is also defined in the following claims, and equivalents thereof.

What is claimed is:

1. A system, comprising:
a first energy input;
a heat output, configured to deliver a portion of an energy flow received at the first energy input;
a heat flow regulator, for controlling a rate of heat flow through the heat output;
a first sensor; and
a controller,
the controller being configured to:
receive a measurement from the first sensor, and
control the heat flow regulator to cause heat to flow at a first heat flow rate through the heat output, the system producing a greater outflow rate of exergy at the first heat flow rate than at a second heat flow rate different from the first heat flow rate.

2. The system of claim 1, wherein:
the first energy input is an input for receiving solar radiation; and
the system further comprises:
a photovoltaic panel, and
a heat sink, configured to receive heat energy and to transfer the heat energy to the fluid.

3. The system of claim 1, wherein the heat output comprises a fluid flow circuit for a fluid.

4. The system of claim 3, wherein the heat flow regulator comprises a pump.

5. The system of claim 3, wherein the heat flow regulator comprises a valve.

6. The system of claim 1, wherein the heat output comprises a heat pipe.

7. The system of claim 6, wherein the heat flow regulator comprises a variable-thermal-conductance element in a thermal conduction path comprising the heat pipe.

8. The system of claim 3, further comprising a means for causing a fluid to flow in the fluid flow circuit.

9. The system of claim 8, wherein the means for causing the fluid to flow comprises convection.

10. The system of claim 9, wherein the heat flow regulator comprises a valve.

11. The system of claim 8, wherein the means for causing the fluid to flow comprises a pump.

12. The system of claim 11, wherein the heat flow regulator comprises a valve.

13. The system of claim 3, wherein the first sensor comprises a temperature sensor.

14. The system of claim 13, wherein the temperature sensor is configured to measure an outlet fluid temperature.

15. The system of claim 14, further comprising a second sensor.

16. The system of claim 15, wherein the second sensor is configured to measure an inlet fluid temperature.

17. The system of claim 15, wherein the second sensor is configured to measure a flow rate.

18. The system of claim 1, wherein the controller is configured to control a voltage or a current to control the heat flow regulator.
